(19) United States
(12) Patent Application Publication
(10) Pub. No.: US 2003/0233233 A1
(43) Pub. Date: Dec. 18, 2003

(54) Speech recognition involving a neural network

(75) Inventor: Wei-Tyng Hong, Tainan City (TW)

Correspondence Address: Finnegan, Henderson, Farabow,, Garrett & Dunner, L.L.P., 1300 I Street, N.W., Washington, DC, 20005-3315, US

(73) Assignee: INDUSTRIAL TECHNOLOGY RESEARCH INSTITUTE

(21) Appl. No.: 10/167,589

(22) Filed: Jun. 13, 2002

(51) Int. Cl. G10L 15/00

(52) U.S. Cl. 704/256

(57) ABSTRACT

Methods and systems for recognizing speech include receiving information reflecting the speech, determining at least one broad-class of the received information, classifying the received information based on the determined broad-class, selecting a model based on the classification of the received information, and recognizing the speech using the selected model and the received information.

### DESCRIPTION

1. Technical Field

The present invention relates to methods, combinations, apparatus, systems, and articles of manufacture involving speech recognition. In one example, speech recognition may involve a neural network.

2. Background

Practical applications of speech recognition must be robust in the face of different channel environments. Some traditional approaches to speech recognition are based on Hidden Markov Models (HMMs). These approaches typically train a single common HMM using a mixed database of utterances (i.e., samples of speech) from a broad range of channel environments. As a result, the accuracy of speech recognition for the mix-trained HMM in one channel environment suffers because the range of channel environments may contain characteristics that differ between the channel environments. That is, the mix-trained HMM may perform adequately among all the channel environments, but not exceptionally well in any one particular channel environment.

As one of ordinary skill in the art will now appreciate, a HMM is a statistical model of speech based on speech samples (e.g., words, sub-words, phonemes, etc.) and the ordering of the speech samples. The HMM may include a state transition matrix reflecting possible sequences of speech samples in time, feature probabilities for each state, and state transition probabilities. The state transition probabilities indicate the likelihood a speech sample will appear at a specific time in the sequence of speech samples given other speech samples in the sequence. The feature probabilities indicate the likelihood that a given speech sample would exhibit a certain feature.

A HMM typically requires training to recognize speech. Training determines the parameters for the state transition matrix, the feature probabilities for each state, and the state transition probabilities. In a mix-trained HMM, the parameters are not specifically tuned to a particular channel environment. In contrast, a match-trained HMM is trained using only utterances from one type of channel environment (i.e., a match channel environment). Hence, the parameters of the match-trained HMM are tuned to its match channel environment and the match-trained HMM may recognize speech in its match channel environment more accurately than a mix-trained HMM. However, the match-trained HMM may not recognize speech in a non-matching channel environment as well as the mix-trained HMM.

### SUMMARY

Methods, combinations, apparatus, systems, and articles of manufacture consistent with features and principles of the present invention may employ a neural network in speech recognition.

One exemplary aspect of the present invention may relate to a method for recognizing speech. The method may comprise receiving information reflecting the speech, determining at least one broad-class of the received information, classifying the received information based on the determined broad-class, selecting a model based on the classification of the received information, and recognizing the speech using the selected model and the received information.

A second exemplary aspect of the present invention may relate to a system for recognizing speech. The system may comprise a receiver for receiving information reflecting the speech, a first recurrent neural network for determining at least one broad-class of the received information, a second recurrent neural network for classifying the received information based on the determined broad-class, a model selector for selecting a Hidden Markov Model based on the classification of the received information, and a recognizer for recognizing the speech using the selected Hidden Markov Model and the received information.

A third exemplary aspect of the present invention may relate to a computer-readable medium. The medium may contain instructions for a computer to perform the steps of receiving information reflecting speech, determining at least one broad-class of the received information, classifying the received information based on the determined broad-class, selecting a model based on the classification of the received information, and recognizing the speech using the selected model and the received information.

Additional aspects of the invention are set forth in the description which follow, and in part are apparent from the description, or may be learned by practice of methods, combinations, apparatus, systems, and articles of manufacture consistent with features and principles of the present invention. It is understood that both the foregoing description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several aspects of the invention and together with the description, serve to explain principles of the invention. In the drawings,

FIG. 1 illustrates an exemplary system for recognizing speech consistent with features and principles of the present invention;

FIG. 2 illustrates an exemplary method for recognizing speech consistent with features and principles of the present invention; and

FIG. 3 illustrates an exemplary recurrent neural network consistent with features and principles of the present invention.

### DETAILED DESCRIPTION

Reference is now made in detail to embodiments consistent with the invention, examples of which are illustrated in the accompanying drawings. Wherever possible, the same reference numbers are used throughout the drawings to refer to the same or like parts.

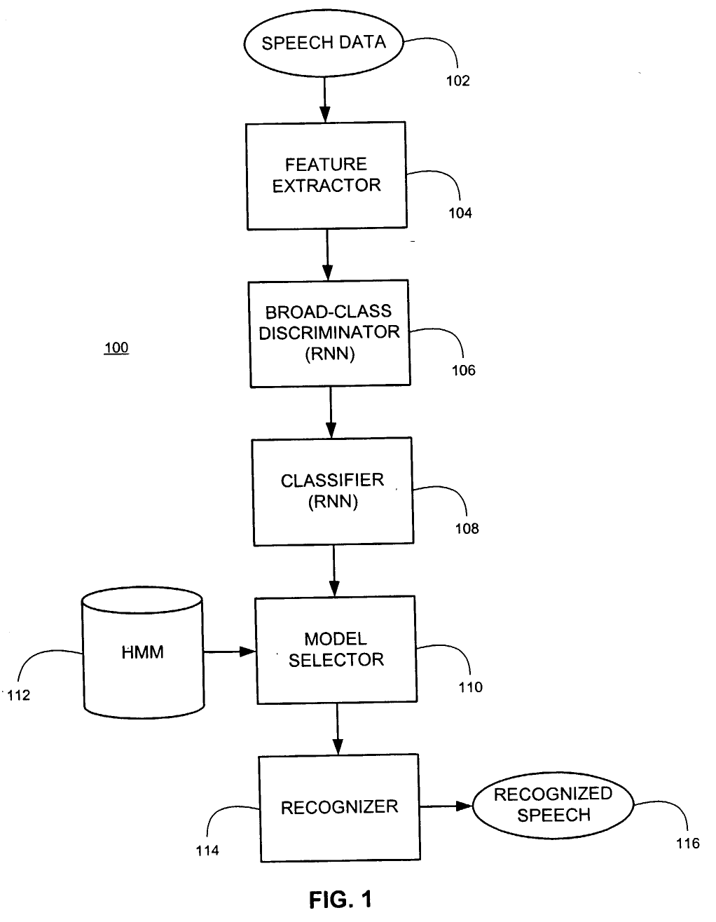

FIG. 1 illustrates an exemplary system 100 for recognizing speech consistent with features and principles of the present invention. System 100 may include a feature extractor 104, a broad-class discriminator 106, a classifier 108, a model selector 110, a database 112 of HMMs, and a recognizer 114. Feature extractor 104 may be coupled to broad-class discriminator 106. Broad-class discriminator 106 may be coupled to classifier 108. Classifier 108 may be coupled to model selector 110. Model selector 110 may be coupled to HMM database 112 and recognizer 114.

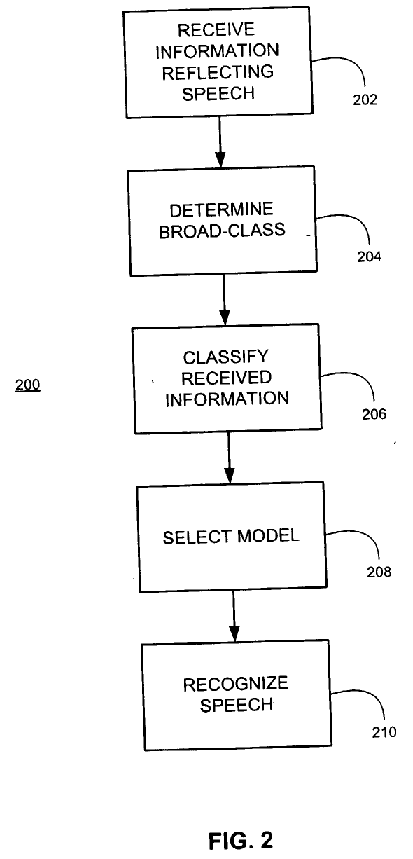

According to features and principles of the present invention, system 100 may be configured to implement the exemplary method illustrated in flowchart 200 of FIG. 2. By way of a non-limiting example, feature extractor 104 may receive speech data 102. Speech data 102 may be a sample of acoustic data (e.g., spoken communication), which may include phonemes, numeric digits, letters, sub-words, words, strings, etc. Speech data 102 may be in any form compatible with the present invention (e.g., digital data obtained via analog-to-digital conversion of acoustic data or other forms).

Feature extractor 104 may extract feature information from speech data 102. The extracted feature information may include spectral information, temporal information, statistical information, and/or any other information that can be used to characterize speech data 102. The feature information may be extracted for each frame of speech data 102. A frame may be defined to be a sub-interval of speech data 102. Frames may be any length, may have differing lengths, and/or may overlap each other. By way of a non-limiting example, speech data 102 may be a sixty-second, digital sample of spoken communication, which may be divided into four consecutive frames of fifteen seconds each.

Broad-class discriminator 106 may receive the extracted feature information for each frame and any additional information reflecting speech data 102 (step 202 in FIG. 2). Broad-class discriminator 106 may receive and process the extracted feature information of each frame in a frame-synchronous mode (i.e., one frame at a time). Broad-class discriminator 106 may determine a broad-class for each frame using the received information (step 204). Broad-class discriminator 106 may determine the broad-class from among several broad-classes (e.g., initial, final, non-speech, etc.). By way of a non-limiting example, if a frame contains the beginning of an interval of speech in speech data 102, then broad-class discriminator 106 may determine that the frame is in the initial broad-class. If a frame contains the end of an interval of speech in speech data 102, then broad-class discriminator 106 may determine that the frame is in the final broad-class. If a frame of speech data 102 does not contain any speech, then broad-class discriminator 106 may determine that the frame is in the non-speech broad-class.

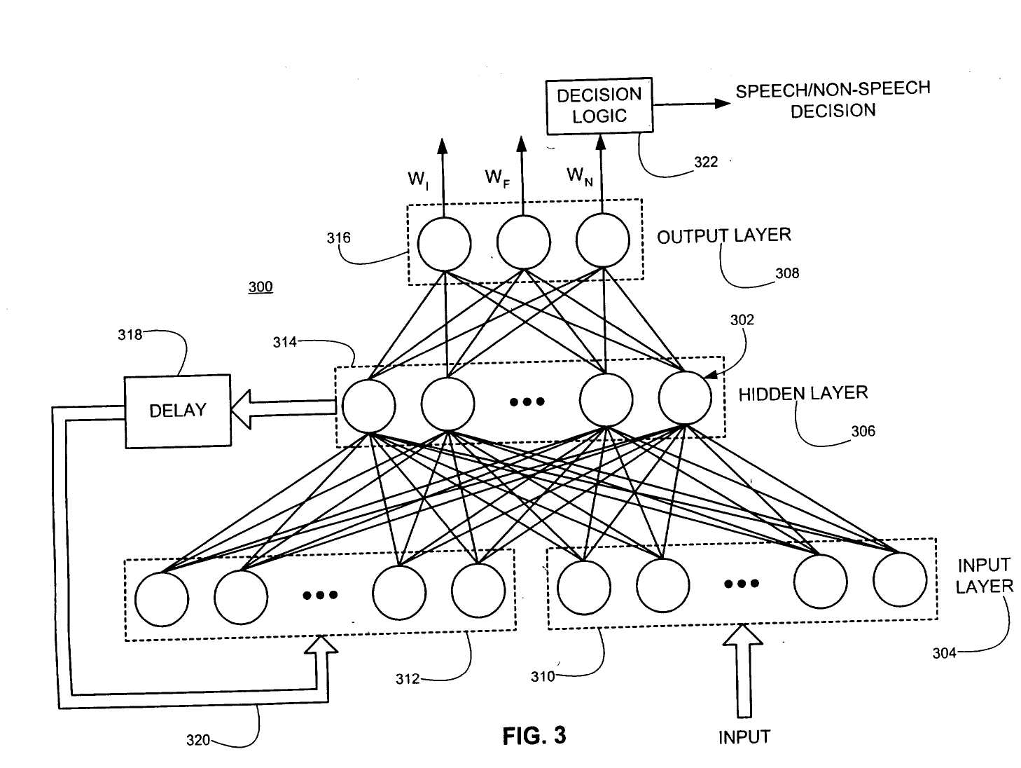

Broad-class discriminator 106 may be a recurrent neural network (RNN) configured and trained to determine the broad-class of a frame using extracted feature information from the frame. FIG. 3 illustrates an exemplary RNN 300 consistent with features and principles of the present invention. RNN 300 may include neurons 302 organized into an input layer 304, a hidden layer 306, and an output layer 308. Input layer 304 may include input neurons 310 and feedback neurons 312. Input neurons 310 may be coupled to hidden neurons 314 in hidden layer 306. Feedback neurons 312 may also be coupled to hidden neurons 314. Hidden neurons 314 may be coupled to output neurons 316 in output layer 308. Hidden neurons 314 may also be coupled to a delay block 318. Delay block 318 may be coupled to feedback neurons 312 via a feedback path 320. Output W_{N} from output layer 308 may be coupled to decision logic 322. The coupling between neurons 302 may be fully connected, partially connected, etc.

Input neurons 310 may receive the extracted feature information of a frame at INPUT in FIG. 3. The extracted feature information may include mel-frequency cepstral coefficients (MFCCs), delta MFCCs (i.e., differences between MFCCs), log-energy of a frame, delta log-energy (i.e., difference between log-energies) of a frame, delta-delta log-energy (i.e., difference between delta log-energies) of a frame, etc. The extracted feature information may form a vector of scalars, wherein each scalar may be a MFCC, a delta MFCC, or any other type of feature.

Input neurons 310 may receive the vector of feature information at INPUT. Each input neuron 310 may accept a scalar from the vector as an input signal and may apply a transfer function to its respective input signal to generate an output signal for each input neuron 310. Each hidden neuron 314 may receive the output signals from input neurons 310. Hidden neurons 314 may also receive output signals from feedback neurons 312. The output signals of the feedback neurons 312 may be time-delayed output signals from hidden neurons 314. The received signals from input neurons 310 and feedback neurons 312 may be numeric values, which may be weighted with multiplicative coefficients. Hidden neurons 314 may combine (i.e., sum and/or subtract) the weighted signals from input neurons 310 and feedback neurons 312 and apply a transfer function to the combined signal to generate an output signal for each hidden neuron 314.

In turn, each output neuron 316 may receive the output signals from hidden neurons 314. The received signals from hidden neurons 314 may be weighted with additional multiplicative coefficients. Output neurons 316 may combine the weighted signals from hidden neurons 314 and apply a transfer function to the combined signal to generate an output signal for each output neuron 316.

As one of ordinary skill in the art will now appreciate, RNN 300 may be trained to produce predetermined output signals from output neurons 316. The output signals may specify that a frame is in a given broad-class whenever RNN 300 receives extracted feature information, at INPUT, that has characteristics uniquely indicative of the given broad-class. By way of a non-limiting example, if a frame contains the beginning of an interval of speech in speech data 102, then extracted feature information for the frame should contain characteristics unique to frames in the initial broad-class. Thus, when RNN 300 receives the extracted feature information for the frame at INPUT, RNN 300 may process the extracted feature information such that WI will be, for example, a positive scalar. The positive scalar for W_{I} may be designed to indicate that the frame is determined by RNN 300 to be in the initial broad-class. Similarly, a positive scalar for W_{F} or W_{N} may be designed to indicate that a frame is determined by RNN 300 to be in the final broad-class or non-speech broad-class, respectively. It should be noted RNN 300 may be designed and trained to provide any arbitrarily predetermined outputs besides positive scalars to indicate the broad-class of a frame.

Further, as one of ordinary skill in the art will now appreciate, W_{N} may be processed using hard decision logic 322 when determining if a frame is in the non-speech broad-class. By way of a non-limiting example, W_{N} may be a continuous numeric value and hard decision logic 322 may quantize W_{N} to a discrete value.

Depending on the broad-class of a frame, classifier 108 may use the frame to classify the type of channel environment that existed when speech data 102 was generated (step 206 of FIG. 2). By way of some non-limiting examples, speech data 102 may be voice data spoken over a public switched telephone network (PSTN), a cellular telephone, a wireless connection, open air, and/or other types of channels. Each channel environment may have unique characteristics that affect the feature information extracted from speech data 102. Therefore, classifier 108 may use the extracted feature information in frames of speech data 102 to determine the type of channel environment that speech data 102 was generated in.

However, certain types of frames in speech data 102 may not be optimal to use when classifying the channel environment. Frames that are deeply influenced by speaker-specific characteristics and uttering contextual variations may adversely affect the accuracy of channel environment classification. For example, frames in the initial broad-class and/or final broad-class may be poor frames to use in channel environment classification. Therefore, classifier 108 may not use extracted feature information from frames determined by broad-class discriminator 106 to be in the initial broad-class and/or the final broad-class.

Classifier 108 may be a RNN-based channel classifier. The formulation of RNN-based channel classification is described below. A RNN-based channel classifier may be derived from a Maximum Likelihood (ML)-based channel classifier satisfying the decision rule,

$${j}^{*} = {argmax}_{j} P ( O \vert {λ}_{j} ) , j = 1 , … , M , \qquad ( 1 )$$

where λⱼ is the j^{th} channel environment of M channel environments, j* is the index of the channel environment most likely to be the channel environment of speech data 102, O={o₁, o₂, . . . , o_{T}} is the extracted feature vectors of T frames of speech data 102, and P(O|λⱼ) is the probability of observing O given channel environment λⱼ.

Under some assumptions, the decision rule may be rewritten as

$${j}^{*} = {argmax}_{j} {\prod }_{t = 1}^{T} \frac{P ( {o}_{t} \vert {λ}_{j} )}{P ( {o}_{t} )} , j = 1 , … , M , \qquad ( 2 )$$

where oₜ is the extracted feature vector of the t^{th} frame of speech data 102, P(oₜ|λⱼ) is the probability of observing oₜ given channel environment λⱼ, P(oₜ) is the probability of observing

$${o}_{t} , and \frac{P ( {o}_{t} \vert {λ}_{j} )}{P ( {o}_{t} )}$$

is the scaled likelihood. The scaled likelihood may be re-written as

$$\frac{P ( {λ}_{j} \vert {o}_{t} )}{P ( {λ}_{j} )} .$$

The probabilities P(λⱼ|oₜ) for each channel environment λⱼ may be estimated by a RNN trained to discriminate the M channel environments (i.e., P(λⱼ|oₜ)=RNNⱼ(oₜ)). For example, given the j^{th} channel environment λⱼ and the t^{th} extracted feature vector oₜ, RNNⱼ(oₜ) may output an estimate for P(λⱼ|oₜ). Hence, Equation 2 may be rewritten as

$${j}^{*} = {argmax}_{j} {\prod }_{t = 1}^{T} \frac{{RNN}_{j} ( {o}_{t} )}{P ( {o}_{t} )} , j = 1 , … , M . \qquad ( 3 )$$

A RNN-based channel classifier may use Equation 3 as its decision rule.

The RNN for classifier 108 may be configured similarly as described for the RNN in broad-class discriminator 106. By way of a non-limiting example, the RNN for classifier 108 may receive extracted feature information from T frames of speech data 102. The RNN for classifier 108 may be configured and trained to output a particular estimate for P(λⱼ|oₜ) when the RNN for classifier 108 receives predetermined extracted feature information as input.

As previously described, classifier 108 may only use frames of a predetermined broad-class to classify the channel environment. This aspect may be incorporated into Equation 3 to yield

$${j}^{*} = {argmax}_{j} {\prod }_{t = 1}^{T} [ \frac{{RNN}_{j} ( {o}_{t} )}{P ( {o}_{t} )} δ ( {C}_{t} ∈ U ) ] , j = 1 , … , M . \qquad ( 4 )$$

where δ(.) is an indicator function, Cₜ is the broad-class of the t^{th} frame, and U is a sub-set of broad-classes. For example, if U only includes a non-speech broad-class, classifier 108 may only use scaled likelihoods of frames determined to be in the non-speech broad-class.

Model selector 110 may select a match-trained HMM, Ω_{j*}, matched to the channel environment most likely to be the channel environment of speech data 102 (step 208). Model selector 110 may select the match-trained HMM, Ω_{j*}, from a set of match-trained HMMs, {Ω₁, Ω₂, . . . , Ω_{M}}, stored on database 112. Recognizer 114 may recognize speech data 102 using the match-trained HMM, Ω_{j*}, and may output recognized speech 116 (step 210). Recognizer 114 may recognize speech data 102 using methods described by Lawrence R. Rabiner in “A Tutorial on Hidden Markov Models and Selected Applications in Speech Recognition”, Proceedings of IEEE, vol. 77, issue 2, pp. 257-286, February 1989, the entirety of which is incorporated herein by reference. Recognizer 114 may also use any other methods compatible with the present invention to recognize speech data 102 based on the match-trained HMM, Ω_{j*}.

In one embodiment consistent with features and principles of the present invention, Mandarin speech databases were collected from 800 toll-free telephone calls to train broad-class discriminator 106, classifier 108, and HMMs in database 112 of system 100. These calls were made on various telephony networks in Taiwan and were made using either wireless Global System for Mobile Communication (GSM) telephones or landline PSTN telephones. Speech data from each call was received and digitally recorded using a PC-based speech server with a Dialogic D/41 ESC card. The speech data was recorded at a sample rate of 8 kHz. Speakers on the telephone calls were required to read sentences from designated scripts.

Two training databases, a GSM training database and a PSTN training database, were employed to train system 100. 36,427 utterances made by 1,969 speakers from a MAT database, described by Hsiao-Chuan Wang in “MAT—A Project to Collect Mandarin Speech Data Through Telephone Networks in Taiwan”, Computational Linguistics and Chinese Language Processing, vol. 2, no. 1, pp. 73-90, February 1997, were used for the PSTN training database. The GSM training database was created using various hand-held phones on GSM telephony networks and contained a total of 23,534 utterances made by 492 speakers. Designated scripts used to produce the GSM training database were drawn from a mix comprising 2% numeric digits, 2.6% individual names, 3.2% Taiwanese city names, 3.2% phrases, 7% continuous speech, and 82% abbreviated Taiwanese stock names. Most of the telephone calls in the GSM training database were made indoors with hand-held GSM devices.

While PSTN and GSM training databases were used to train system 100, testing databases were created to evaluate system 100 after training. Table 1 illustrated the properties of various testing databases (i.e., TS-G, TS-P, TS-SVMIC, TS-CAR1, and TS-CAR2). The testing databases were collected using a designated list of abbreviated Taiwanese stock names spoken by speakers over a telephone call. The second column of Table 1 lists the environment type of each speaker when his/her utterances were recorded over the telephone call. The last column of Table 1 shows an average SNR for each testing database.

TABLE 1
Testing Databases

| Testing | | Number of | Number of | SNR |
|---|---|---|---|---|
| Database | Environment | Speakers | Utterances | (dB) |
| TS-G | Quiet Office | 15 | 771 | 37.2 |
| TS-P | Quiet Office | 11 | 1136 | 38.2 |
| TS-SVMIC | Public Place | 2 | 208 | 40.2 |
| TS-CAR1 | Running Car | 1 | 104 | 15.9 |
| TS-CAR2 | Running Car | 1 | 312 | 36.0 |

The first group of testing databases consisted of TS-G and TS-P, which were collected with GSM hand-held mobile phones and PSTN-based telephones, respectively. The second group of testing databases consisted of TS-SVMIC, TS-CAR1, and TS-CAR2. TS-SVMIC was generated from a hands-free skin vibration-activated microphone attached to a GSM mobile phone. The hands-free microphone only responded to throat skin vibration of a speaker's neck, so background noises were mostly suppressed. Hence, TS-SVMIC had the highest SNR value. TS-SVMIC was intended to be used to examine the diverse effects of hands-free devices on system performance.

TS-CAR1 was obtained using hand-held GSM phones in a car moving at an average speed of approximately 60 km/hr on a highway. The telephone calls placed to create TS-CAR2 were also recorded in a moving car. However, TS-CAR2 was obtained by directly sending speech signals from playback machines, such as a CD player, into the hand-held GSM mobile phones using a connection cable. In this manner, car noise was not induced into speech data recorded in TS-CAR2. The average speed of the moving car in TS-CAR2 was also approximately 60 km/hr. The speech data stored in the playback machine was pre-recorded by a female speaker in a quiet office environment and each word was clearly pronounced. TS-CAR2 was intended to be used to evaluate the performance of system 100 when speech data 102 was only corrupted by fading on a GSM channel produced by a moving car.

All recorded speech signals from the testing databases were first pre-processed using a 20-ms Hamming window with a 10-ms shift. A set of 26 recognition features including 12 MFCCs, 12 delta MFCCs, a delta log-energy, and a delta-delta log-energy was computed for each frame. The cepstral mean normalization, obtained by subtracting the average cepstral mean per utterance from the recorded speech signal, was used to minimize channel-induced variations. Three evaluations concerned with GSM and PSTN channel environments were performed. The first evaluation studied the performance of a RNN-based broad-class discriminator in determining initial, final, and non-speech broad-classes for frames of Mandarin speech. The second evaluation studied the performance of a RNN-based channel classifier. The last evaluation studied the performance of system 100 in recognizing speech containing abbreviated Taiwanese stock names.

In the first evaluation, the performance of the RNN-based broad-class discriminator was compared against a ML-based broad-class discriminator. Both broad-class discriminators used the same feature information extracted by a feature extractor and both were trained using the GSM training database. The number of hidden nodes of the RNN-based broad-class discriminator was empirically set to one hundred. As one of ordinary skill in the art will now appreciate, the ML-based broad-class discriminator used a mixture of Gaussian distributions. The mixture included three Gaussian distributions, all with diagonal covariance matrices to model the likelihood probabilities for the three broad classes to be classified. The number of mixture components in each distribution was empirically set to sixty-four. Both broad-class discriminators operated in a frame-synchronous mode to discriminate each input frame among three broad-classes of initial, final, and non-speech. Recorded speech data from the testing databases in Table 1 were processed by the broad-class discriminators to compare the performance between the two discriminators.

Table 2 tabulates the broad-class discrimination error rates of the RNN-based broad-class discriminator and the ML-based broad-class discriminator. It should be noted that TS-G was well-matched to the GSM training database, but TS-P was not well-matched to the GSM training database. This is because TS-G and the GSM training database were both created using telephone calls made over a GSM channel, but TS-P was created using telephone calls made over a landline PSTN channel. Further, TS-SVMIC, TS-CAR1, and TS-CAR2 were highly mismatched to the GSM training database because of various effects inherent in hands-free devices, GSM channel fading, and car noise.

TABLE 2
Error Rates of Broad-Class Discriminators

| Testing | ML-Based Discriminator | RNN-Based Discriminator |
|---|---|---|
| Database | Error Rate (%) | Error Rate (%) |
| TS-G | 13.2 | 6.1 |
| TS-P | 14.9 | 6.3 |
| TS-SVMIC | 17.0 | 8.2 |
| TS-CAR1 | 18.3 | 12.0 |
| TS-CAR2 | 14.5 | 7.7 |
| Average | 15.6 | 8.1 |

As illustrated in Table 2, a comparison of the error rates for the two broad-class discriminators tested using TS-G and TS-P showed the performance of the RNN-based discriminator degraded very slightly from TS-G to TS-P. However, the error rate of the ML-based discriminator increased by a factor of 12.9%. This illustrated the robustness of the RNN-based broad-class discriminator in the face of different environments.

The performances of the two broad-class discriminators for TS-SVMIC were poor, even though the SNR of TS-SVMIC was greater than 40 dB. This was due to the large mismatch in the spectral properties between the hands-free skin vibration-activated microphone used to create TS-SVMIC and the hand-held GSM telephone used to create the GSM training database. For TS-CAR2, the error rates of the discriminators increased because packets were lost due to GSM fading channel effects generated by the moving car. The worst error rates occurred with TS-CAR1, because the recorded speech data in TS-CAR1 was simultaneously corrupted by GSM fading channel effects and additive moving car noise. Regardless, the RNN-based discriminator significantly outperformed the ML-based discriminator for all the testing databases. As illustrated in Table 2, on average, the RNN-based discriminator achieved a 48% drop in the error rate when compared to the ML-based discriminator.

In the second evaluation, the performance of the RNN-based channel classifier for GSM and PSTN channel classes (i.e., M=2 in Equation 3) was studied. The RNN-base channel classifier was trained to determine the channel environments of recorded speech data in the GSM and the PSTN training databases. The average error rate for the RNN-based channel classification over all the testing databases when not combined with a broad-class discriminator (i.e., using the decision rule in Equation 2) was 14.0%. This was taken as the baseline performance. Table 3 presents the performance of the RNN-based channel classification when combined with the broad-class discriminator (i.e., using the decision rule in Equation 3).

Table 3 illustrates the average error rate over all the testing databases when the RNN-based channel classifier included frames of different combinations of broad-classes (i.e., initial, final, and/or non-speech) to classify the channel environment of recorded speech data in the testing databases. {I}, {F}, and {N} indicate that frames used during channel classification only included frames in the initial broad-class, the final broad-class, and the non-speech broad-class, respectively. {F, N}, {I, N}, and {I, F} mean frames in the final and non-speech broad-classes, frames in the initial and non-speech broad-classes, and frames in the initial and final broad-classes, respectively, were used during channel classification.

The best error rate in Table 3 was 10.7%, which was a drop in the average error rate by factor of about 24% from the baseline performance. As illustrated in Table 3, the inclusion of initial and non-speech frames (i.e., U={I, N} in Equation 3) when classifying the channel environment of speech data greatly improved the RNN-based channel classification. In contrast, the inclusion of final frames was adverse to RNN-based channel classification.

TABLE 3
Average Error Rate of RNN-based Channel Classifier

| U | {I} | {F} | {N} | {F, N} | {I, N} | {I, F} |
|---|---|---|---|---|---|---|
| Average | 19.5 | 21.9 | 12.8 | 12.0 | 10.7 | 18.7 |
| Error | | | | | | |
| Rate (%) | | | | | | |

In the third evaluation, the performances of system 100 and other speech recognition schemes were compared. As one of ordinary skill in the art will now appreciate and as described by L. S. Lee in “Voice Dictation of Mandarin Chinese”, IEEE Signal Processing Magazine, pp. 17-34,1994, sub-syllable-based HMMs with 100 three-state right-final-dependent initial models and 38 five-state context-independent final models were used to recognize speech data. In each state of the HMMs, a mixture of Gaussian distributions with diagonal covariance matrices were used. The number of distributions in the mixture for each state was variable and depended on the number of training samples, but a maximum number of thirty-two mixtures was set for initial and final models and ninety-six mixtures for non-speech (or silence) models. The vocabulary of speech data included 963 words, and each word consisted of two to four syllables. Although, the vocabulary was only of medium size, word recognition was actually difficult because it included many easily confused words. TS-P and TS-G were used to evaluate the performance of system 100 and the other recognition schemes in recognizing speech from GSM/PSTN channel environments.

The other recognition schemes included a “Matched” scheme and a “Mixed-Up” scheme. The HMMs in the Matched scheme were trained and tested under matched conditions (i.e., TS-G was used to test HMMs trained with the GSM testing database and TS-P was used to test HMMs trained with the PSTN testing database). The HMMs in the Mixed-Up scheme were trained using all recorded speech data from the GSM and the PSTN training databases.

Table 4 presents the performance results for the Matched scheme, Mixed-Up scheme, and system 100. The Matched scheme's performance was used as a benchmark. A comparison of the error rates between the Matched scheme and the Mixed-Up scheme showed an increase by a factor of 42% in the average error rate from the Matched scheme to the Mixed-Up scheme. This suggested that network mismatch between PSTN and GSM was significant. The error rates of system 100 were comparable to those of the Matched scheme. System 100 had a drop on the average error rate by a factor of about 24% from the Mixed-Up scheme's average error rate.

TABLE 4
Performance Results for Matched Scheme,
Mixed-Up Scheme, and System 100

| Testing | Matched Scheme | Mixed-Up Scheme | System 100 |
|---|---|---|---|
| Database | Error Rate (%) | Error Rate (%) | Error Rate (%) |
| TS-G | 6.5 | 11.6 | 7.6 |
| TS-P | 10.2 | 12.1 | 10.4 |
| Average Error | 8.4 | 11.9 | 9.0 |
| Rate | | | |

In one embodiment of the present invention, system 100 may be implemented using a processor or using a plurality of processors. Processors may include computers, digital signal processing boards, application specific integrated circuits, hardware, etc. The processor(s) may be configured to perform the method illustrated in FIG. 2. Alternatively or additionally, system 100 may be implemented using software. Software make include computer programs, instructions stored on readable storage media, etc.

In the foregoing description, broad-class discriminator 106 (FIG. 1) determined whether a frame belonged in an initial broad-class, a final broad-class, and/or a non-speech broad-class. However, other types of broad-classes may be defined for the frame, and classifier 108 may or may not use frames from the other types of broad-classes when classifying a channel environment. Further, classifier 108 may classify other characteristics of speech data 102 based on other criteria besides channel environment. By way of a non-limiting example, classifier 108 may classify the gender of a person speaking speech data 102 and model selector 110 may select a HMM matched to persons of the same gender. Recognizer 112 may then use the gender matched-HMM to recognize speech data 102. Or classifier 108 may classify the noisiness of an environment in which speech data 102 was generated and model selector 110 may select a HMM matched to environments with the same level of noisiness. Recognizer 112 may then use the noise matched-HMM to recognize speech data 102. Additional criteria (e.g., quiet office, public place, running car, etc.) compatible with features and principles of the present invention may also be used by classifier 108.

Also in the foregoing description, various features are grouped together in various embodiments for purposes of streamlining the disclosure. This manner of disclosure is not to be interpreted as reflecting an intention that the claimed invention requires more features than may be expressly recited in each claim. Rather, as the following claims reflect, inventive aspects may lie in less than all features of a single foregoing disclosed embodiment. Thus, the following claims are hereby incorporated into this description, with each claim standing on its own as a separate embodiment of the invention.

What is claimed is:

1. A method for recognizing speech, comprising:
receiving information reflecting the speech;
determining at least one broad-class of the received information;
classifying the received information based on the determined broad-class;
selecting a model based on the classification of the received information; and
recognizing the speech using the selected model and the received information.

2. The method of claim 1, wherein the received information comprises extracted feature information.

3. The method of claim 2, wherein the extracted feature information comprises at least one of spectral feature information, temporal feature information, and statistical feature information.

4. The method of claim 1, wherein the determined broad-class is chosen from an initial broad-class, a final broad-class, and a non-speech broad-class.

5. The method of claim 1, wherein the received information comprises information reflecting at least one frame of the speech, wherein determining the broad-class of the received information comprises determining a broad-class of the frame, and wherein classifying the received information does not use the frame if the broad-class of the frame is determined to be an initial broad-class.

6. The method of claim 1, wherein the received information comprises information reflecting at least one frame of the speech, wherein determining the broad-class of the received information comprises determining a broad-class of the frame, and wherein classifying the received information does not use the frame if the broad-class of the frame is determined to be a final broad-class.

7. The method of claim 1, wherein the classification of the received information comprises at least one of a channel classification, an environment classification, and a speaker classification.

8. The method of claim 7, wherein the channel classification comprises at least one of a wireless channel classification and a wired channel classification.

9. The method of claim 7, wherein the environment classification comprises at least one of a quiet office classification, public place classification, and running car classification.

10. The method of claim 1, wherein the selected model is a Hidden Markov Model.

11. The method of claim 1, wherein a recurrent neural network determines the broad-class of the received information.

12. The method of claim 1, wherein a recurrent neural network classifies the received information.

13. A system for recognizing speech, comprising:
a receiver for receiving information reflecting the speech;
a first recurrent neural network for determining at least one broad-class of the received information;
a second recurrent neural network for classifying the received information based on the determined broad-class;
a model selector for selecting a Hidden Markov Model based on the classification of the received information; and
a recognizer for recognizing the speech using the selected Hidden Markov Model and the received information.

14. The system of claim 13, wherein the received information comprises extracted feature information.

15. The system of claim 13, wherein the extracted feature information comprises at least one of spectral feature information, temporal feature information, and statistical feature information.

16. The system of claim 13, wherein the determined broad-class is chosen from an initial broad-class, a final broad-class, and a non-speech broad-class.

17. The system of claim 13, wherein the received information comprises information reflecting at least one frame of the speech, wherein the first recurrent neural network determines a broad-class of the frame, and wherein the second recurrent neural network does not use the frame if the broad-class of the frame is determined to be an initial broad-class.

18. The system of claim 13, wherein the received information comprises information reflecting at least one frame of the speech, wherein the first recurrent neural network determines a broad-class of the frame, and wherein the second recurrent neural network does not use the frame if the broad-class of the frame is determined to be a final broad-class.

19. The system of claim 13, wherein the classification of the received information comprises at least one of a channel classification, an environment classification, and a speaker classification.

20. The system of claim 19, wherein the channel classification comprises at least one of a wireless channel classification and a wired channel classification.

21. The system of claim 19, wherein the environment classification comprises at least one of a quiet office classification, public place classification, and running car classification.

22. A computer-readable medium containing instructions for a computer to perform the steps of:
receiving information reflecting speech;
determining at least one broad-class of the received information;
classifying the received information based on the determined broad-class;
selecting a model based on the classification of the received information; and
recognizing the speech using the selected model and the received information.
